(19) United States
(12) Patent Application Publication
(10) Pub. No.: US 2026/0072647 A1
(43) Pub. Date: Mar. 12, 2026

(54) AUTOMATION PLAN CREATION AND VALIDATION USING GENERATIVE AI

(71) Applicant: Microsoft Technology Licensing, LLC, Redmond, WA (US)

(72) Inventors: David Robert REABURN, Redmond, WA (US); Ashvini SHARMA, Redmond, WA (US); Methil Harysh MENON, Kirkland, WA (US)

(21) Appl. No.: 18/827,578

(22) Filed: Sep. 6, 2024

(51) Int. Cl. G06F 8/30; G06F 40/20

(52) U.S. Cl. CPC G06F 8/30; G06F 40/20

(57) ABSTRACT

Examples provide a system and method for dynamically improving and validating automation plans using generative artificial intelligence (AI). An automation manager analyzes automation plans during the design phase and the testing phase. The automation plan makes suggestions for improving the automation plan in real time using natural language prompts. The automation plan validates the automation plan against guardrails defining restrictions on the actions performed by the system during automation plan execution. The system generates explainability data describing the next planned actions and reasons why each planned action is selected for execution during the automation to increase user confidence in the automation. The system requests user approval prior to performing each action for more accurate and efficient workflow automation while reducing system resource usage consumed during execution of inefficient or ineffective automation plans.

### BACKGROUND

An automation workflow is a resource for deploying and utilizing automation technologies. An automation workflow is capable of automatically performing tasks to achieve the goals and objectives of users. An automation workflow has an automation plan which is a natural language description of the work to be done by an automatable resource. The automation workflow performs or executes tasks automatically by connecting to and utilizing resources, such as applications and/or cloud services. However, manual creation of automation plans is frequently a time consuming and inefficient process which can be difficult and error prone. This potentially discourages many users from attempting to create and utilize automation workflows.

### SUMMARY

Some examples provide a system and method for dynamic creation, testing and validation of automation plans using generative artificial intelligence (AI) models. An automation manager processes and executes an automation plan using natural language inputs provided by a user. The automation manager detects a missing portion of the automation plan using a generative AI model, such as a large language model (LLM). A variable is placed into the automation plan to represent the missing portion. A suggestion is generated which includes a request for additional information needed to correct the missing portion of the automation plan. The automation plan is updated in real-time using the additional information provided in response to the suggestion. The variable is replaced with the missing portion of the automation plan obtained from the additional information. This updates the incomplete automation plan to a completed automation plan automatically. A next action to be performed in accordance with the completed automation plan is validated against a set of guardrails. The set of guardrails include restrictions customized for the completed automation plan. The automation manager requests user approval to perform the next action. The next action is triggered in response to receiving the user approval via the UI device, thereby reducing errors in the creation, testing and validation of the automation plan in real time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for assisting a user in creating and improving an automation plan using generative artificial intelligence (AI).

FIG. 2 is an exemplary block diagram illustrating automatically correcting an automation plan in real-time to remove errors and prevent execution of non-functional automation plans using a generative AI model.

FIG. 3 is an exemplary block diagram illustrating a system including an automation manager for creating and validating an automation plan to automate tasks for users more efficiently and accurately with reduced system resource usage.

FIG. 4 is an exemplary flow chart illustrating operation of the computing device to detect missing information in an automation plan and update the automation plan during a design phase and testing phase.

FIG. 5 is an exemplary flow chart illustrating operation of the computing device to validate a next action in an automation plan.

FIG. 6 is an exemplary flow chart illustrating operation of the computing device to validate and approve a next action using a generative AI model.

FIG. 7 is an exemplary flow chart illustrating operation of the computing device to execute a completed automation plan.

FIG. 8 is an exemplary diagram illustrating a screenshot of a user interface associated with creation of an automation plan assisted by an automation manager at a design phase.

FIG. 9 is an exemplary diagram illustrating a screenshot of a workflow management page including historical runtime information for a single automation plan.

FIG. 10 is an exemplary diagram illustrating a screenshot 1000 of a prompt requesting additional information from the user during a testing phase.

FIG. 11 is an exemplary block diagram illustrating a screenshot 1100 of an approval prompt showing explainability data, a guardrail check result and a next action to be performed.

FIG. 12 is a block diagram of an example computing device for implementing aspects disclosed herein and is designated as computing device.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Automation plans created by users are frequently incomplete or fail to function as intended when the plan is initially created. Rather, users frequently are required to perform manual iterative updates and modifications to the plans in a pain-staking editing and testing of the plan before a functional automation plan capable of performing as desired and achieving the user's goals is obtained. This is a time-consuming, laborious, and tedious process for users. Moreover, designing, testing, and editing an automation plan can be a highly technical task, requiring specialized skills which prevents many users lacking these specialized skills from utilizing available automations.

Referring to the figures, examples of the disclosure enable an automation manager component, which is computer-implemented, to use a generative artificial intelligence (AI) model to create, improve, and validate automation plans. In some examples, the automation manager enables users to specify their automation needs using natural language inputs while letting the generative AI model intelligently identify missing information in the automation plan, dynamically improve the plan for more effective and accurate automations, as well as intelligently selecting and sequencing actions for greater ease of use and accessibility to users. The system further uses the generative AI to understand and execute tasks based on natural language input provided in real time during the design, testing and/or validation phases of the automation plan for reduced errors, simplicity of use, and improved efficiency of users via the natural language interface.

Aspects of the disclosure further enable an automation manager that converts incomplete automation plans into completed automation plans ready for execution to perform desired automated tasks for a user with minimal human intervention. In some examples, the automation manager detects inefficiencies and missing information in the automation plan and generates suggestions and recommendations for updates to the plan for a user to confirm. This enables the system to dynamically correct problems in the automation plan by updating the automation plan during the design phase and/or the testing phase, thereby improving usability of automations while also reducing automation failures occurring during runtime. By using LLMs, the automation manager can leverage the vast ever-expanding knowledge and the fast-evolving reasoning capabilities of LLMs, coupled with the simplicity of natural language, and create automations that are more human-like, flexible, and intelligent.

The system, in some examples, enables a design phase, a testing phase and a runtime phase. The user can execute an automation plan in a preview mode prior to the runtime phase where each action is confirmed before proceeding. The user can provide feedback to the plan manager component on how to proceed. This enables dynamic and interactive design and testing of automation plans for improved plan efficiency and accuracy while further improving user interaction to more easily create automations while also improving user confidence in the automation.

During a runtime phase, in other examples, the system employs generative AI to evaluate the steps of the automation plan, determine the correct actions to execute, and fill in dynamic values throughout the course of the automation plan execution. This enables more dynamic automations while reducing system resource usage consumed in executing faulty automations, error handling, and/or error messaging wherein automations fail to execute as desired by the user.

In still other examples, the system reduces system resource usage, such as processor and memory usage, consumed in executing faulty or inefficient automation plans during runtime, by updating automation plans to eliminate potential problems in the automation plan during the design and testing phases. The system analyzes automation plans during design and testing phases to reduce processor, memory and network bandwidth usage consumed executing automations that fail to produce desired performance, result in bad runs, and/or produce outputs undesired by the user.

In other examples, the system provides suggestions to improve the automation plans and/or correct errors in the automation plans dynamically during design and testing via natural language messaging between the automation manager and the user. This enables the user to easily and more efficiently create automation plans and/or update automation plans with minimal coding, increased speed creating the automation plans, improved user efficiency via the UI interaction, and increased user interaction performance.

The computing device operates in an unconventional manner by utilizing generative AI to understand and execute tasks based on natural language input while dynamically providing suggestions for improving automation plans and validating automation actions against user configured guardrails constraining the available actions, thereby reducing errors occurring during execution of automation plans. In this manner, the computing device is used in an unconventional way, and allows reduced usage of system resources, such as processor, memory, and network bandwidth usage consumed during execution of automation plans having missing information, errors, or unintentional actions undesired by the user, thereby improving the functioning of the underlying computing device. The automation manager further enables increased speed creating and testing automation plans, conserves memory usage during automation plan execution, reduces processor load during automation plan execution, reduces network bandwidth usage consumed during execution of faulty or inefficient automations, reduces the rate of errors associated with automation plans, and improves user efficiency via the natural language UI interaction.

The computing device, in other examples, operates in an unconventional manner by automatically converting an incomplete automation plan having missing information into a completed automation plan that is ready for execution when triggered to perform automated actions via an automation resource to achieve one or more goals of the user, thereby reducing user time and resources spent manually testing and editing incomplete automation plans. Moreover, the system enables users lacking specialized training to utilize automations by providing an automation manager capable of identifying missing portions of information in an incomplete automation plan and automatically converting that incomplete automation plan into a completed automation plan without any missing portions of information that is ready for execution while minimizing human interaction and reducing errors in the automation plans.

In other examples, the system enables a user to specify goals and guardrails for an automation directly in the automation plan design phase. The guardrails enable creation of broader user-defined constraints customized for each automation as set by the user at design time using natural language inputs to the system. This improves the quality of the automation resource outputs as well as reduces user time spent designing and creating automation plans.

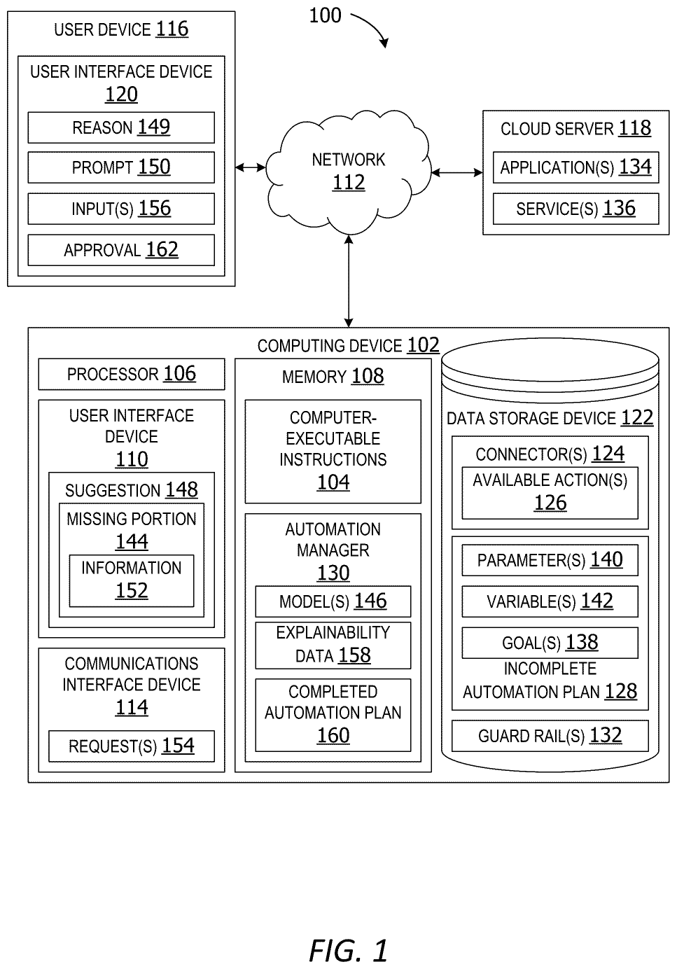

Referring again to FIG. 1, an exemplary block diagram illustrates a system 100 for assisting a user in creating and improving an automation plan using generative artificial intelligence (AI). In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

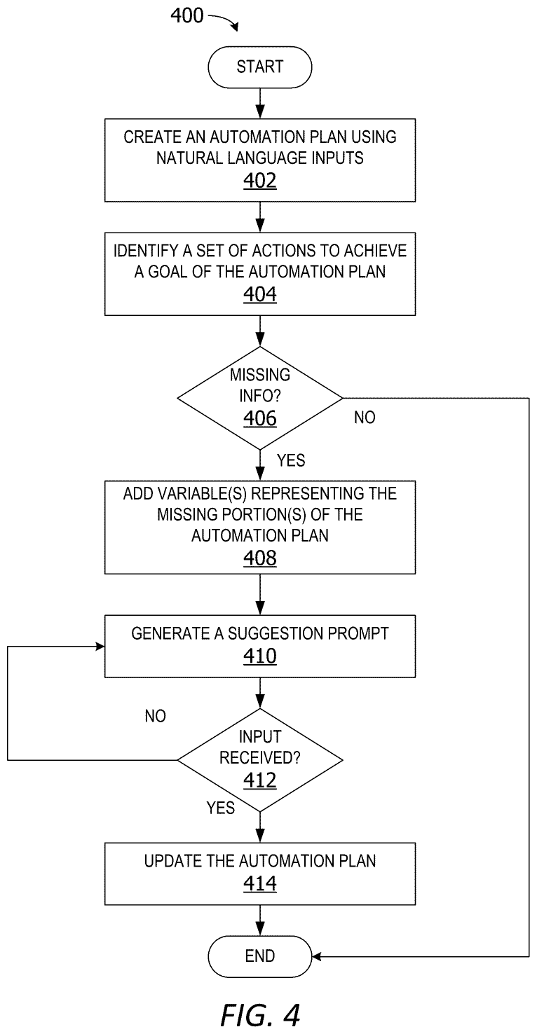

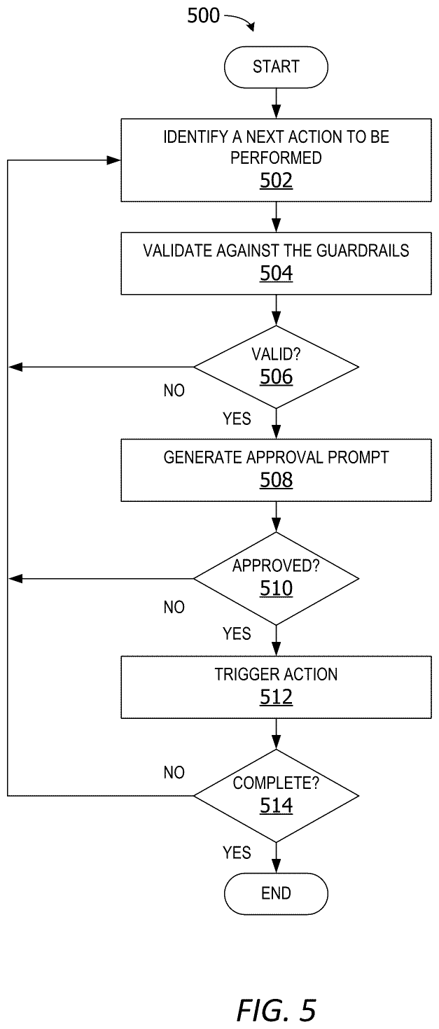

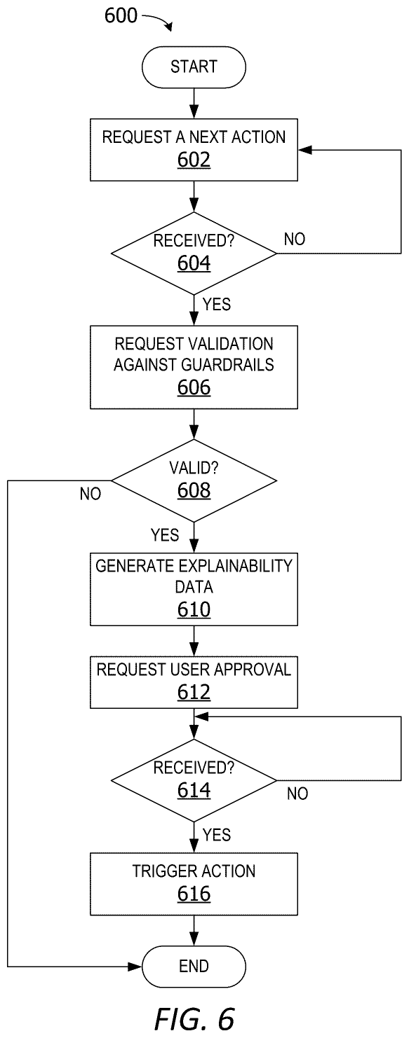

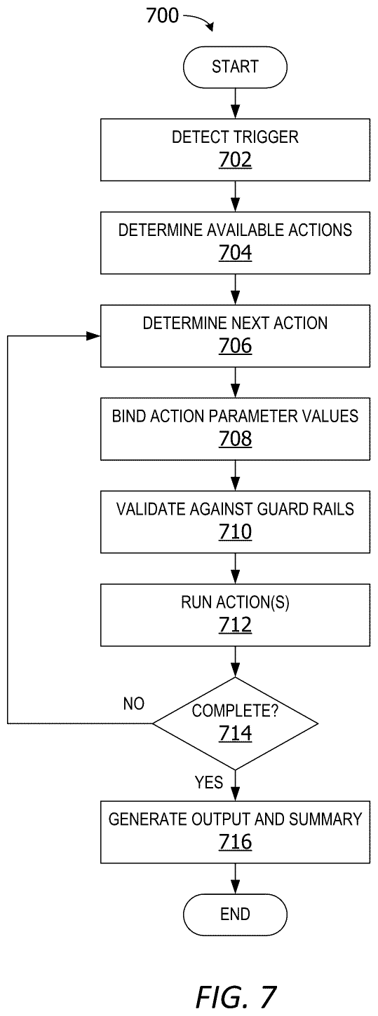

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4, FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device 120.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 122 for storing data, such as, but not limited to one or more connector(s) 124, an incomplete automation plan 128, and/or one or more guardrail(s) 132 customized for the automation plan 128. An automation manager 130, in some examples, incorporates a generative AI model enabling a user to describe what the user wants to automate, and the automation manager makes it happen. The incomplete automation plan 128 is an automation plan 128 which is missing one or more pieces of information which renders the incomplete automation plan 128 incapable of being executed to perform the one or more goals of the user.

The connector(s) 124 include one or more connector(s) enabling the automation manager 130 to access one or more application(s) 134 and/or one or more service(s) 136 providing resources for performing one or more actions, such as, but not limited to, the available action(s) 126. The available action(s) 126 include actions the automation manager 130 is capable of performing during execution of one or more actions or other work described by the incomplete automation plan 128.

The incomplete automation plan 128 is a plan describing one or more goal(s) 138 of a user. A goal is an objective or desired outcome. A goal can include, for example, sending an email, updating a file, copying a file, sending a message, posting a message to a social media account, protecting a computing device from cyber-attacks, controlling resolution of a display device, workload balancing in a data center, or any other type of goal. Other goals which may be used comprise controlling a digital robot or controlling a physical robot. The incomplete automation plan 128 optionally includes action parameter(s) 140. An action parameter is a parameter associated with an action. A parameter can include any type of information or parameter value for performing an action. For example, if the action is sending an email, an action parameter can include a value for the email recipient, email subject, or any other information associated with performing the send email action. In the case of controlling resolution of a display, the parameter may be a screen resolution. If the action is controlling a digital or physical robot, the action is sending an instruction to the digital or physical robot and an action parameter can include an identifier or address of the digital or physical robot.

A variable in the one or more variable(s) 142 is a string, token, or other placeholder value representing an unknown action parameter value. For example, if the action is to send an email to a designated recipient where the subject is unknown, a variable can be used to represent the unknown subject of the email within the automation plan. Once the automation manager identifies the subject or the user provides a subject for the email, the variable value for the subject is replaced with the actual subject of the email for use during execution of the incomplete automation plan 128 when an event triggers sending of the email to the designated recipient.

In some examples, the variable type defines the properties of the variable, as well as the UI that is required to prompt the user for a value. Some variables include dynamic list variables. A dynamic list variable is a variable representing a dynamic list, the contents of which are unknown until runtime because the contents of the dynamic list change frequently. A dynamic list variable can include, for example, a list of files in a shared document location. In such cases, the system prompts a user who refers to a dynamic list, such as a shared documents list, for both the shared documents site universal resource locator (URL) and a list name. The additional properties, such as “value” for each variable depend on the type.

In some examples, the actions are initially limited to just connector actions. In other examples, the actions include child flows and various forms of ‘wildcard’ connector matching. A connector wildcard is a connector indicating that any action from this connector is acceptable. A full wildcard designation indicates that any connector action from any connector (for which a connection is available) is acceptable.

Connector actions point to a particular application programming interface (API), and to be ready to run, require a valid connection reference. The API enables interfacing with an automatable resource. For example, the API may be an API of a digital robot, or an API of a physical robot for interfacing to the digital and/or physical robots. A valid connection reference is defined in the automation plan as a key in the connection references workflow property. This connection reference uses the same API and has a valid connection. A connector display name allows a UI to distinguish between multiple references to the same connector if they use different connections.

The guardrail(s) 132 include one or more user-configured restrictions applicable to one or more of the actions in the pool of available action(s) 126. An available action is an action which the automation manager 130 can trigger via a connector in the connector(s) 124, subject to the constraints and restrictions described in the guardrail(s) 132. The guardrails are obtained from a natural language response provided by a user via a user interface device, such as, but not limited to, the user interface device 110.

The set of connector(s) 124 can include dozens, hundreds or even thousands of connectors. For example, an available action in the pool of available action(s) 126 can include an action to automatically draft (write) an email and/or automatically send an email to one or more recipients. In this example, a connector in the set of connector(s) 124 for connecting the automation manager to an email application is used thereby enabling the system to automatically generate and/or send the email to one or more recipients without human intervention.

In another example, an available action includes automatically alerting a user of an event, such as creation of a new file in a file system. In this example, a connector enabling connection to the file system and/or a connector enabling the system to connect to a messaging system is utilized. The file system connector enables the automation manager to identify newly created files. The messaging system connector enables the automation manager to connect to the messaging system, automatically generate a message and/or automatically transmit the message via the messaging system without human intervention.

The data storage device 122 can include one or more different types of data storage devices, such as, for example, one or more rotating disks drives, one or more solid state drives (SSDs), and/or any other type of data storage device. The data storage device 122 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 122 includes a database.

The data storage device 122 in this example is included within the computing device 102, attached to the computing device, plugged into the computing device, or otherwise associated with the computing device 102. In other examples, the data storage device 122 includes a remote data storage accessed by the computing device via the network 112, such as a remote data storage device, a data storage in a remote data center, or a cloud storage.

The memory 108 in some examples stores one or more computer-executable components, such as, but not limited to, the automation manager 130 to create, test, update, and/or validate automation plans. An automation workflow is some automatable resource having an automation plan that is processed and executed by an automation manager component. The automation plan includes a natural language description of the work or goal the user wants performed. The user describes the goal or other work to be performed with natural language input that is understood when it executes. During the execution, generative AI is used to consider, select, and carry out a sequence of actions to accomplish a result or goal that the human user has defined in the automation plan. The automation manager simplifies the process of creating effective and error-free automation plans, such that barriers preventing users from creating customized automation plans are lowered or removed, thereby increasing user access to automatable resources.

In some examples, the automation manager component, when executed by the processor 106 of the computing device 102, creating the incomplete automation plan 128 using one or more natural language goal(s) 138 provided by a user via a user interface (UI) device, such as, but not limited to, the user interface device 110 and/or the user interface device 120. The automation manager 130 detects a missing portion 144 of the incomplete automation plan 128 by a generative artificial intelligence (AI) model in the model(s) 146. In this example, the model(s) 146 includes at least one generative AI large language model (LLM).

In some examples, the automation manager 130 generates a suggestion 148 recommending the user provide additional information 152 needed to complete the incomplete automation plan 128. The recommendation for the additional information is made via a prompt 150. The prompt 150 is output to the user via the user interface device 120 and/or the user interface device 110. The prompt 150 includes one or more request(s) 154 for the missing portion 144 of the incomplete automation plan. The automation manager 130 automatically updates the automation plan in real-time using the additional information 152 provided by the user via one or more input(s) 156.

In other examples, the automation manager 130 validates a next action to be performed in accordance with the completed automation plan 160 against the set of one or more guardrail(s) 132. The completed automation plan is a plan having the missing portions filled in to create a complete automation plan that is ready to be executed during the runtime phase. The completed automation plan 160 is executable to accomplish the user's stated automation goals. The completed automation plan 160 can be referred to as an updated automation plan. In some examples, the completed automation plan 160 is stored in a data storage device until execution of the completed automation plan is triggered, such as, but not limited to, the data storage device 122 and/or a cloud storage.

The guardrail(s) 132 include rules (constraints) that are customized for each available action in the pool of available action(s) 126 based on natural language guidelines provided as input by the user via a UI device. The automation manager 130 generates explainability data 158 associated with the planned next action to be performed during execution of the automation plan associated with the automation plan and/or the automatically completed automation plan.

The explainability data 158 includes an automatically generated description of the next planned action to be triggered and a reason 149 the next action was selected by the generative AI model(s) 146 The explainability data is generated in response to validation of the next action in light of the guardrail(s) 132. If the next action violates a guardrail, the next action is invalid. If the next action does not violate any guardrail, the next action is validated. This provides improved granularity of user control over actions performed during the automation enabling fine-tuned adjustments to the automation.

The reason 149 provided in the explainability data provides the user with insight into why a particular action is chosen by the AI. This further improves user interaction with the system while also reducing errors occurring during testing and runtime, as the user is able to intervene to prevent undesired actions from being performed after reviewing the explainability data prior to execution of the next planned action.

The automation manager 130 requests user approval to perform the next action via a UI device, such as, but not limited to, the user interface device 110 and/or the user interface device 120. The automation manager 130 triggers performance of the next action in response to receiving the user approval 162 via the UI device. For example, if the incomplete automation plan 128 is a plan to send an email to a designated recipient each morning, the next action to be performed in the automation plan can include connecting to an email server to send the email for the current day. In this example, the automation manager 130 outputs a description of the next action (connect to the email server) with a reason 149, such as by stating the connection to the email server is being made to enable sending of the email. The reason and a prompt 150 requesting user approval is presented to the user via the user interface device 120. In this manner, the user can approve the action or cancel the action if the action is erroneous or undesired.

In some examples, detection of missing portions of the automation plan occurs during a design phase and/or during a testing phase. Validation of each planned next action is performed during the testing phase and/or during a runtime phase. Generating the explainability data 158 and/or the reason 149 associated with each next planned action is performed during the testing phase and/or the runtime phase. Obtaining user approval 162 prior to triggering performance of each action is performed during the testing phase and/or the runtime phase. This enables automated action while still providing a user the opportunity to understand what actions the automation manager is taking, provide feedback or make changes in real-time, as well as cancel undesired actions before they take place. This further reduces system resource usage, such as processor usage and network bandwidth usage, consumed performing undesirable or erroneous actions in the course of executing the automation.

The automation manager 130 leverages generative AI (LLM) to understand the intent and context of the goal(s) 138 set by the human user in a natural language conversation with the automation manager, and then dynamically generates an automation plan to meet this goal. The automation manager 130 creates and executes the automation plan and has access to the entire pool (portfolio) of available actions supported by the ecosystem of connectors in the automation platform and by custom connectors specific to a particular user's environment.

In some examples, the human user sets guardrail(s) 132 for safe execution of the automation plan customized for a particular automatable resource, which ensures that the human user controls the boundaries of autonomy of the automation workflow. A guardrail is any limitation, rule, or restriction placed on one or more of the actions performed in accordance with a specific automation plan. A guardrail is obtained from natural language inputs provided by a user. The user describes actions the user approves or disapproves for a particular resource and/or a specific automation plan. The automation manager applies natural language processing (NLP) to extract the guardrails from the user-provided natural language inputs.

Guardrails associated with an email-related action can include, for example, a list of contacts to whom emails can be sent, a list of contacts to whom emails should not be sent, when emails can be sent, when emails cannot be sent, email addresses which should not be included as a recipient of emails, email addresses that should be blocked, or any other limitations on actions performed by the automation manager. If the automation plan is designed to send an email to designated recipients when an event occurs, such as a new file is created or a file is updated, the guardrail can specify limitations on when the emails should be sent or contacts that should not receive the update emails. For example, a guardrail can specify that email notifications regarding updates should only be sent between the hours of nine in the morning and five in the afternoon. This restricts the times during which updates should be sent. Other guardrails can limit sending automated email updates to certain days or restricting sending of emails on certain holidays, etc.

The guardrails are stored on a data storage device, such as on a database. The automation manager retrieves the guardrails for a particular automation plan from the data storage device during execution of the automation plan. As the AI model identifies a next automated action to be performed during execution of the automation plan, the AI model validates each action against the guardrails (if any) to determine if the guardrails prohibit a proposed next action. If the proposed next action violates one or more of the guardrails, the proposed next action is rejected by the automation manager. The automation manager then requests a new proposed next action from the AI model that falls within the user-defined guardrails.

In some examples, the guardrails are updated or modified in real-time during execution of an automation plan. In these examples, the user can make changes to the guardrails where the automation plan execution is failing to provide the desired results and/or the desired goal(s) of the user without requiring changes to automation plan code or policies.

When an automation plan associated with an automation resource executes, the automation manager uses a generative AI model to understand the context that it is invoked in, the inputs provided by the user, and the outputs required to be produced by the automation workflow at the end of the automation plan execution. At every step of execution, the automation manager, in conjunction with one or more generative AI model, dynamically selects the most appropriate actions to achieve the desired outcome(s), validating its reasoning to confirm its not violating any guardrails, and executes it, providing more efficient automation with reduced system resource usage, demonstrating dynamic binding of the automation plan actions at execution time.

The generative AI model in some examples is being validated by itself in response to a separate validation request provided to the generative AI model by a non-generative AI model in the model(s) 146. In other examples, the model(s) 146 includes two or more generative AI models as well as at least one non-generative AI model. In these examples, a first generative AI model is validated by a second generative AI model in response to the second generative AI model receiving the validation request from the non-generative AI model in the model(s) 146.

In this example, the model(s) 146 are incorporated within the automation manager 130. However, in other examples, one or more of the generative AI model(s) are implemented as a separate component on a separate computing device or cloud server, such as the cloud server 118. In these examples, the automation manager 130 exchanges information with the model(s) via the network 112.

The system 100 enables dynamic and adaptable workflow automation that leverages generative AI to create and execute dynamic automation plans. The automation plan is specified with natural language that is evaluated at runtime. At the time of execution, generative AI is used to reason over and dynamically select and execute a sequence of actions to achieve an outcome or goal defined by a human.

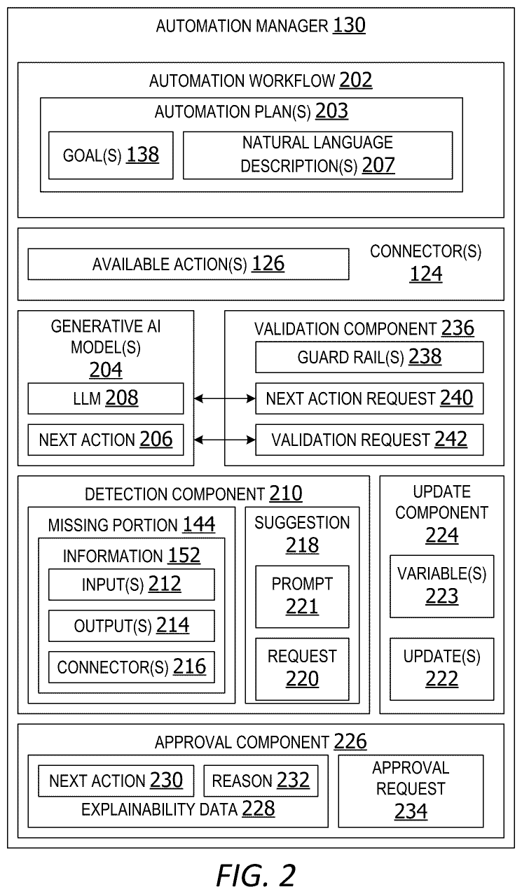

FIG. 2 is an exemplary block diagram illustrating an automation manager 130 for automatically correcting an automation plan in real-time to remove errors and prevent execution of non-functional automation plans using a generative AI model. This enables users to refine and customized automations without requiring the specialized knowledge which would be necessary to manually create, test and validate such automations.

In some examples, an automation workflow 202 includes one or more automation plan(s) 203 for achieving one or more goal(s) 138 via one or more software automation tools available via one or more connector(s) 124 associated with a pool of one or more available action(s) 126. The one or more automation plan(s) 203 include natural language description(s) 207 of work to be performed or goals to be achieved provided by a user. The automation plan(s) 203 include plans, such as, but not limited to, the automation plan 128 and/or the completed automation plan 160 in FIG. 1.

The automation manager 130 utilizes one or more AI models, such as, but not limited to, one or more generative AI model(s) 204. The generative AI model(s) 204 include models capable of identifying each next action 206 to be performed from the pool of available action(s) 126 dynamically during execution of an automation plan associated with the automation workflow 202 in runtime mode. The generative AI model(s) 204 are capable of receiving and interpreting natural language inputs and/or natural language requests provided by a user. In some examples, the generative AI model(s) 204 include at least one large language model (LLM) 208.

A detection component 210 in some examples, identifies a missing portion 144 of an automation plan in real-time during the design phase when the automation plan is being created and/or during the testing phase when the automation plan is being tested and validated. The missing portion 144 of the automation plan includes information 152 which is required to complete the automation tasks. In some examples, the missing portion 144 includes actions associated with the automated workflow 202, such as, but not limited to, input(s) 212 to be provided by the user, output(s) 214 to be generated during execution of the automation plan and provided to the user, and/or connector(s) 216 required to access one or more applications, cloud services, or other software tools enabling performance of an action needed to complete the automation plan(s) 203 of the automation workflow 202.

If a missing portion 144 of information 152 is identified, one or more variable(s) 223 are inserted into the incomplete automation plan at each location in the automation plan where a missing portion of information is detected. The detection component generates a suggestion 218 which is output to the user via a user interface, such as, but not limited to, the user interface device 110 in FIG. 1 and/or the user interface device 120 in FIG. 1. The suggestion 218, in some examples, includes a prompt 221. The prompt 221 provides a dialog box or other input field prompting the user to provide the requested information corresponding to one or more of the variable(s) 223, provide approval for a suggested action and/or provide rejection of a suggested action.

The suggestion 218, in other examples, includes a request 220 for the user to provide the needed information, such as an action connector, input data, and/or output data. If the user provided the requested information, an update component 224 of the automation manager 130 performs one or more update(s) 222 to the automation plan. In some examples, the update involves replacing the one or more variable(s) 223 with information corresponding to the missing portions of the automation plan. In other words, the missing portions of the automation plan are replaced with information that completes the plan and eliminates the missing portions. Each variable representing a missing piece of information in the automation plan, such as a connector or dynamic information, is replaced with the needed information that completes the automation plan. In this manner, an incomplete automation plan which is incapable of being executed to achieve the goals of the user is converted automatically into a completed automation plan which is ready to be executed to achieve the goals of the user via an automation.

During the update(s) 222, the automation manager 130 replaces variables for unknown parameters in the automation plan with the information provided by the user in response to the suggestion 218. For example, if the automation plan(s) 203 of the automation workflow 202 specifies a goal of sending an email to a specific recipient each time a new file is created in a shared folder, but the automation plan does not include the email address of the recipient, the automation manager adds a variable in place of the email address and requests the email address via the suggestion 218. In this example, if the user provides the email address in response to the request 220, the update component 224 updates the automation plan by replacing the email address variable with the provided email address of the specific recipient.

In other examples, during the testing phase and/or during the runtime phase, an approval component 226 generates explainability data 228 for each next action 230 that is identified by the generative AI model(s) 204. The explainability data 228 is data generated by the generative AI model to explain the decisions of the generative Ai model. The explainability data includes data, such as, but not limited to, the explainability data 158 in FIG. 1.

The explainability data 228 is output to the user via a UI device. The explainability data 228 includes the generative AI model(s) next planned action to be performed and the generative AI model(s) reason 232 for selecting that next action 230. Generating a reason 232 for each planned next action assists the generative AI model(s) 204 in generating more accurate and reliable results. In other words, the generative AI model(s) 204 select better actions to be taken during execution of the automation plan if the generative AI model(s) 204 are required to provide a reason 232 for output to the user in explainability data 228. In some examples, the explainability data is published to an audit log during runtime rather than presenting the explainability data 228 to the user via a UI device.

In still other examples, the approval component 226 outputs the next action 230 identified by the generative AI model(s) 204 to be triggered during execution of the one or more automation plan(s) 203 associated with the automation workflow with an approval request 234 prior to triggering the next action 230. If approval is received from the user, the automation manager 130 triggers performance of the next action 230. If the user does not approve, the user has the opportunity to stop execution of the automation plan, trigger exception handling, or take other action to prevent the next action 230 from being performed.

In this example, if approval is not received from the user via the UI device, the next action is not triggered by the automation manager 130. In this example, the automation plan execution is paused until additional instructions or action is taken by the user.

In some examples, a validation component 236 requests the next action 206 from the generative AI model(s) via a next action request 240. In this example, the generative AI model is a LLM model, such as, but not limited to, a generative AI LLM 208. The next action request includes identification of the automation plan, a list of actions already performed during execution of the automation plan, and the request for the next action to be performed. In response to receiving the next action 206, the validation component 236 submits a e validation request 242 to the generative AI LLM 208.

The validation request 242, in this example, is a request for the AI model to validate the next action against the guardrail(s) 238. In other words, the AI model selects a next action to perform in response to a first request. The AI model then validates the next action in response to a separate second request. The generative AI model compares the next action 206 against the restrictions specified by the user in the guardrail(s) 238 to determine whether the next action is valid. The validation component triggers the AI model to perform the validation of the next action in a separate ML model analysis which can identify errors made by the AI model when selecting the next action in response to the previous request. In this manner, the automation manager essentially double checks the automation actions using multiple inquiries to the AI model.

In the above example, the same AI model selects the next action and validates the next action. However, in other examples, a first AI model selects the next action, and a second AI model validates the next action. In this example, the validation component triggers the validation by the second AI model by sending a request to the second AI model and obtaining the response back from the second AI model.

For example, if the next action is to send an email to a recipient A and a recipient B, but the guardrail(s) 238 specify that no emails are to be sent to recipient B, the next action is invalid. However, if the next action 206 only specifies sending the email to recipient A and the guardrails only restrict sending emails to recipient B, then the next action is valid. The results of the guardrails validation is returned to the validation component 236. If the next action is valid, the system proceeds with generating the explainability data 228 and/or obtaining the user approval to trigger performance of the next action.

In this example, the validation component sends the next action request 240 and the validation request 242 to the same generative AI LLM 208. However, in other examples, the next action request 240 is sent to a first generative AI model and the validation request 242 is sent to a different second generative AI model. In this example, the first generative AI model selects a next action to be performed based on all the previous actions which have already been executed and a prediction of which action should be performed next in furtherance of a goal specified in the automation plan. Once the next action is identified by the first AI model, the validation component 236 receives the next action 206 identification from the first model and stores the identification of the next action on a data storage device. The validation component then generates a validation request requesting validation of the next action in light of the actions already executed and the goals specified in the automation plan. The validation component generates the validation request. The validation request includes the identification of the next action.

The validation component, in this example, then sends the validation request to a second generative AI model in the generative AI model(s) 204. The second model access the guardrail(s) customized for the automation plan from the data storage device, such as a cloud storage accessed via a network or a local data storage device. The second generative AI model compares the next action against the guardrail(s). If the next action violates any guardrail, the next action is invalidated. For example, if the next action is to identify a recipient of an email and a guardrail specifies acceptable recipients for any emails sent by the automation manager, the second generative AI model checks the list of recipients selected by the first generative AI model against the list of unacceptable recipients identified by the user in the guardrail(s). If a recipient is included in the guardrail list of unacceptable recipients, the next action is invalided. If the recipients are not identified in the guardrail list of unacceptable recipients, the next action is validated.

If the next action is acceptable in light of the guardrail(s), the second generative AI model checks the actions already executed and determines if the identified next action is appropriate for achieving the desired goal(s) specified in the automation plan. If the next action is valid against the guardrail(s) 238 and validated as an appropriate next step in the automation, then the second model validates the next action. The second AI model returns the validation results to the validation component.

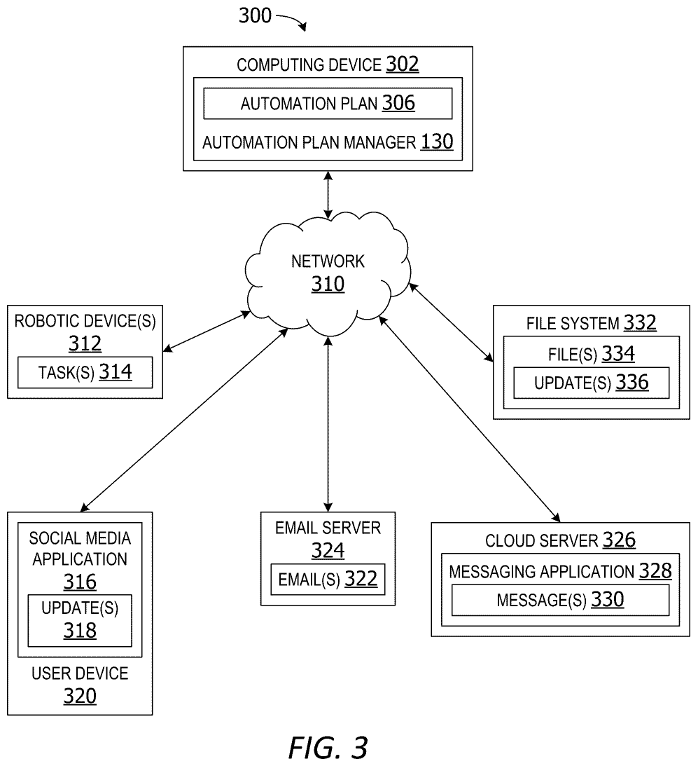

Turning now to FIG. 3, an exemplary block diagram illustrating a system 300 including an automation manager 130 for creating and validating an automation plan 306 to automate tasks for users more efficiently and accurately with reduced system resource usage is shown. In this example, the automation manager 130 helps a user create and update an automation plan 306 more accurately and efficiently via a generative AI model. The automation plan 306 is created, tested, validated and executed on a computing device 302. The computing device is a device having a processor and a memory, such as, but not limited to, the computing device 102 in FIG. 1.

The automation plan performs a series of actions during runtime mode designed to automate tasks. A task is any type of automatable task or action, such as, but not limited to, automating one or more task(s) 314 performed by one or more robotic device(s) 312, performing one or more update(s) 318 to a social media profile associated with a social media application 316 associated with a user device 320, generating/sending email(s) 322 via an email server 324 or other email application, posting message(s) 330 to a messaging application 328 associated with a cloud server 326, performing one or more update(s) 336 to one or more file(s) 334 on a file system 332, copying files, emailing documents or other attachments, or any other tasks capable of automation. The robotic device(s) 312 may be solely digital robotic devices or may be physical robotic devices such as domestic robotic vacuum cleaners, domestic robotic lawn mowing devices, or other physical robotic devices.

The automation manager 130 connects to client devices and/or remote computing systems via a network 310. The network 310 is a network such as, but not limited to, the network 112 in FIG. 1. The client device and/or remote computing systems include, for example, the robotic device(s) 312, social media application 316, email server 324, cloud server 326, and/or file system 332. The automation manager accesses services and tools supplied by the client devices and/or remote computing systems via connectors, such as, but not limited to, the connector(s) 124 in FIG. 1. The results generated by the automation workflows include actions performed by the robotic device(s), updates to files, messages posted to social media websites and/or messaging applications, transmitting information such as emails to recipients, and other automated tasks.

The automation manager 130 enables the user to more quickly and easily generate a functional and accurate automation plan capable of achieving the user goals with minimal coding because the user is able to provide inputs used to create the automation plan using natural language inputs, such as spoken words or typed text. Moreover, the automation manager performs missing information detection, testing, and validation to ensure the automation plan is successful in generating desired results (outputs) for the user while minimizing errors during automation plan creation. The end goal of controlling an automatable resource, such as a robotic device, in the real world is also improved.

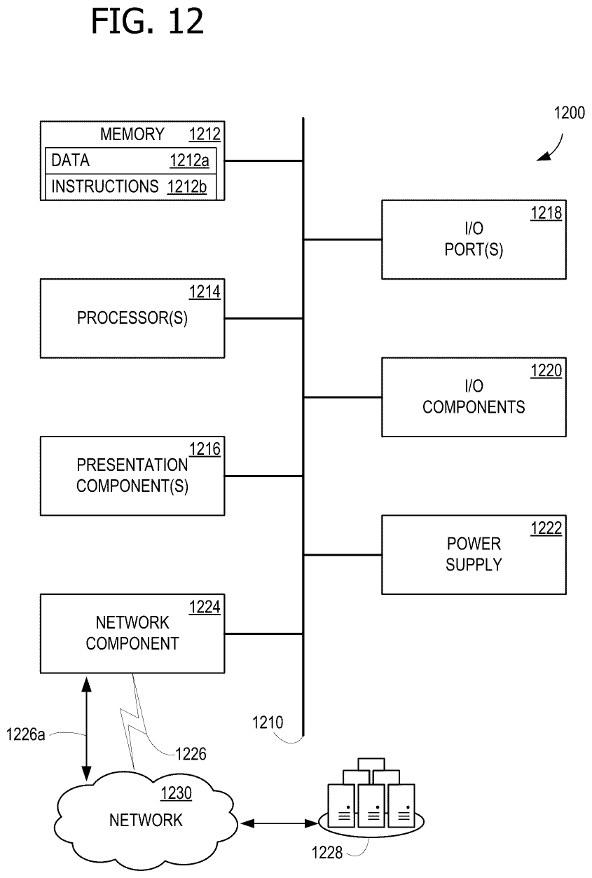

FIG. 4 is an exemplary flow chart illustrating operation of the computing device to detect missing information in an automation plan and update the automation plan during a design phase and testing phase. The process 400 shown in FIG. 4 is performed by an automation manager component, executing on a computing device, such as the computing device 102 in FIG. 1, the user device 116 in FIG. 1, the computing device 302 in FIG. 3, the user device 320 in FIG. 3, and/or the computing device 1200 in FIG. 12.

The process begins by creating an automation plan using natural language inputs at operation 402. The natural language inputs are provided by a user via a user interface, such as, but not limited to, the user interface device 110 and/or the user interface device 120 in FIG. 1. A set of actions to achieve a goal of the automation plan is identified at operation 404. The set of actions includes one or more actions, such as, but not limited to, the available action(s) 126 in FIG. 1 and/or the next action 230 in FIG. 2. A determination is made whether any information is missing from the automation plan at operation 406. In some cases the determination is made by asking a generative AI model, such as an LLM, whether the automation plan is complete. An LLM may be prompted with the automation plan and asked to state whether the automation plan is complete or not and to explain why. In some cases, the determination is made by using rules or templates. In an example, the automation plan is parsed into a list of actions which have action parameters. Rules are used to check if any of the action parameters have missing values, dynamic list variables, or outlier values. If an action parameter value is missing, a dynamic list variable, and/or is an outlier value, the automation plane is determined to have missing information. The automation workflow has at least one automation plan describing work to be done for achieving a goal, such as, but not limited to, the incomplete automation plan 128 in FIG. 1, the completed automation plan 160 in FIG. 1, and/or the automation plan 306 in FIG. 3. If missing information is detected, the automation manager adds one or more variable(s) representing the missing portion(s) of the automation plan at operation 408. The missing portion of the automation plan includes any missing information, such as, but not limited to, input data, output data, and/or action connectors. The automation manager generates a suggestion prompt at operation 410. The suggestion prompt includes a request for the user to provide the identified missing information, such as, but not limited to, the suggestion 218 in FIG. 1. A determination is made whether input is received in response to the suggestion prompt at operation 412. The input is received via a UI device. If input is not received, the system outputs another prompt at operation 410. If the input is received, the automation plan is updated at operation 414 using the input data from the user. The automation plan is updated to create a complete automation plan that is no longer missing any portions of the plan. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to validate a next action in an automation plan. The process 500 shown in FIG. 5 is performed by an automation manager component, executing on a computing device, such as the computing device 102 in FIG. 1, the user device 116 in FIG. 1, the computing device 302 in FIG. 3, the user device 320 in FIG. 3, and/or the computing device 1200 in FIG. 12.

The process begins by identifying a next action to be performed at operation 502. The next action is determined using a generative AI model, such as, but not limited to, one or more of the model(s) 146 in FIG. 1, and/or one or more of the generative AI model(s) 204 in FIG. 2. The next action is validated against the guardrails at operation 504. The guardrails, in this example, include one or more user configured restrictions or constraints on the action(s), such as, but not limited to, the guardrail(s) 132 in FIG. 1 and/or the guardrail(s) 238 in FIG. 2. A determination is made whether the next action is valid at operation 506. If the next action is not valid, the generative AI model identifies a next action at 502. If the action is valid at operation 506, the automation manager generates an approval prompt at operation 508. The approval prompt is a request for approval to perform the next action, such as, but not limited to, the prompt 150 in FIG. 1. The approval prompt is output to the user via a UI device, such as, but not limited to, the user interface device 110 and/or the user interface device 120 in FIG. 1. A determination is made whether the next action is approved by the user at 510. If the user provides input indicating approval of the next action, the next action is determined to be approved. If the automation manager fails to receive input from the user indicating approval, a determination is made that the next action is not approved. If approved at operation 510, the automation manager triggers performance of the action at operation 512. A determination is made whether the automation plan is complete at operation 514. The automation plan is complete when the generative AI model indicates there are no additional actions to be performed or all actions have already been performed. If the automation plan is complete at operation 514, the process terminates thereafter. In some examples, an indication that the automation plan is complete is output to the user with any expected results/outputs and/or a summary of the results.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to validate and approve a next action using a generative AI model. The process 600 shown in FIG. 6 is performed by an automation manager component, executing on a computing device, such as the computing device 102 in FIG. 1, the user device 116 in FIG. 1, the computing device 302 in FIG. 3, the user device 320 in FIG. 3, and/or the computing device 1200 in FIG. 12.

The process begins by requesting a next action at operation 602. The next action is requested from a generative AI model, such as, but not limited to, one or more of the model(s) 146 in FIG. 1 and/or one or more of the generative AI model(s) 204 in FIG. 2. A determination is made whether identification of the next action is received at operation 604. If not, the process returns to operation 602. If a next action is received from the generative AI model, the automation manager requests validation of the next action against guardrails at operation 606. The validation of the next action is requested from a generative AI model. A determination is made whether the next action is valid at operation 608. The next action is valid if the generative AI model indicates that the next action is not restricted by the guardrails. If the next action is valid, the automation manager generates explainability data at operation 610. The explainability data identifies the next action and reason the next action is being recommended. The explainability data is output to a user or logged in an audit log. The automation manager requests user approval to perform the next action at operation 612. A determination is made whether user approval is received at operation 614. If yes, the next action is triggered at operation 616. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

Turning now to FIG. 7, an exemplary flow chart illustrating operation of the computing device to execute a completed automation plan is shown. The process 700 shown in FIG. 7 is performed by an automation manager component, executing on a computing device, such as the computing device 102 in FIG. 1, the user device 116 in FIG. 1, the computing device 302 in FIG. 3, the user device 320 in FIG. 3, and/or the computing device 1200 in FIG. 12.

The process begins by detecting an automation plan trigger at operation 702. A trigger is an event which triggers execution of one or more actions associated with the automation plan, such as a predetermined date and time, a scheduled start time, or any other type of event. The automation manager determines available actions at operation 704. Available actions are actions associated with connectors which the automation manager can perform, such as, but not limited to, the pool of available action(s) 126 in FIG. 1 and/or FIG. 2. A next action is determined at operation 706. In this example, the next action is determined by a generative AI model using the automation plan, a list of actions already performed during execution of the automation plan, and the list of available actions which the system can perform. Action parameter values are bound to the appropriate parameters in the automation plan at operation 708. The next action is validated against guardrails at operation 710. In this non-limiting example, the guardrails are user-configured guardrails generated based on natural language guidelines provided by a user via a UI, such as, but not limited to, the user interface device 110 in FIG. 1. The action(s) are run at operation 712. Running the actions comprises converting the natural language plan into software which comprises connector actions that plug in to APIs of digital or physical robots or other software processes in order to carry out the plan. A determination is made whether the automation plan is complete at operation 714. If not, the system returns to operation 706 and determines the next action to be performed. The system iteratively executes operations 706 through 714 until the automation plan is complete. An output and summary is generated at operation 716. The output includes all expected/desired results/outputs to be generated by the system during execution of the automation plan. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

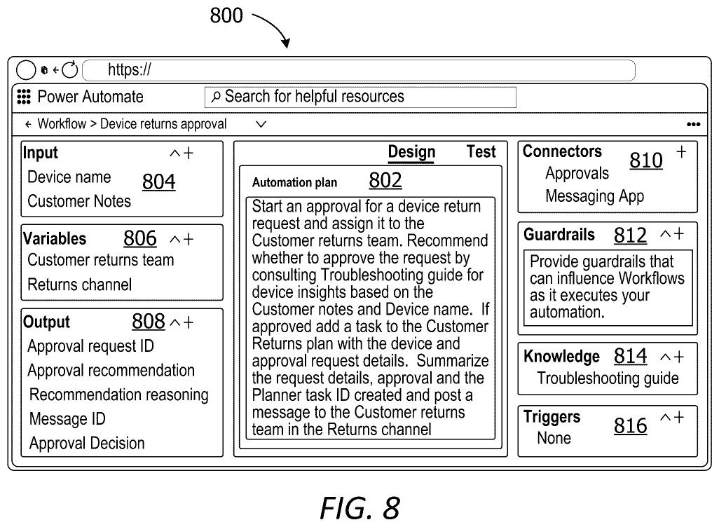

FIG. 8 is an exemplary diagram illustrating a screenshot 800 of a user interface associated with creation of an automation plan assisted by an automation manager at a design phase. The structured variables, such as input 804, variables 806, and output 808, can be referenced by the automation description provide by the user via the automation plan input field 802. In this example, the automation plan is associated with return of a device to a merchant. The input 804 in this example includes the returned device name and notes provided by the customer attempting to return the device. The variables 806 include token values used to represent missing information in the automation plan. In this non-limiting example, the variables 806 include customer returns team and returns channel variables. The output 808 generated by the automation workflow is returned to the user at the completion of the automation plan execution in this example includes return approval request identifier (ID), approval recommendation, recommendation reasoning, a message ID for a messaging application, and approval decision.

The connectors 810 include connectors for accessing available actions. In this example, the connectors 810 include connectors for approval and the messaging application used to send messages. The guardrails 812 include constraints which provide guidance and restrictions on actions performed during runtime. The guardrails are provided by the user via an input field. The guardrails influence workflows as the automation plan executes.

The knowledge 814 includes a troubleshooting guide. The knowledge can be used by the generative AI LLM for action execution/outcome evaluation. Triggers 816 include events which trigger performance of one or more actions in the automation plan.

In this example, an automation plan definition is provided in natural language via the automation plan input field 802. The automation plan created at the design phase using the natural language inputs is evaluated by a generative AI model, such as an LLM, at runtime. In this example, a user provides an input stating “start an approval for a device return request and assign it to the customer returns team.” The user hits a “generate” button or other control to trigger creation of an automation plan for a product return validation. The automation manager recognizes that the email address for the customer returns team is missing, such as by using rules or other criteria. In other examples, the automation manager recognizes information is missing by running the automation plan during a testing phase. If the automation plan fails to execute correctly during the testing phase, the automation manager recognizes that information is missing. Rules or other criteria can then applied to identified the missing information. The system inserts a variable representing the email address of the customer returns team or other missing information into the automation plan during the design phase and/or during the testing phase. In this example, a recommendation is included to consult a troubleshooting guide for insights based on the customer notes and the device (product) being returned.

The automation manager generates explainability data which are output to the user identifying a reason why each action is taken during automation plan execution. The explainability data generated in this non-limiting example states “based on the goal, a new approval needs to be created with a recommendation on the approval and appropriate details from the customer notes and troubleshooting guide.” The explainability data encourages greater confidence in the generative AI models decisions and actions taken during automation plan execution, as well as providing a record of the generative AI model's reasoning for each action taken which can be helpful during exception handling.

The guardrails are created based on natural language inputs provided by the user. The guardrails are customized for each automation plan. In this scenario, an example guardrail states, “ensure the collection of information regarding returns respects customer privacy and adheres to data protection policies.” The guardrails are applied to each proposed action prior to performing the action to ensure all actions performed adhere to user configured restrictions.

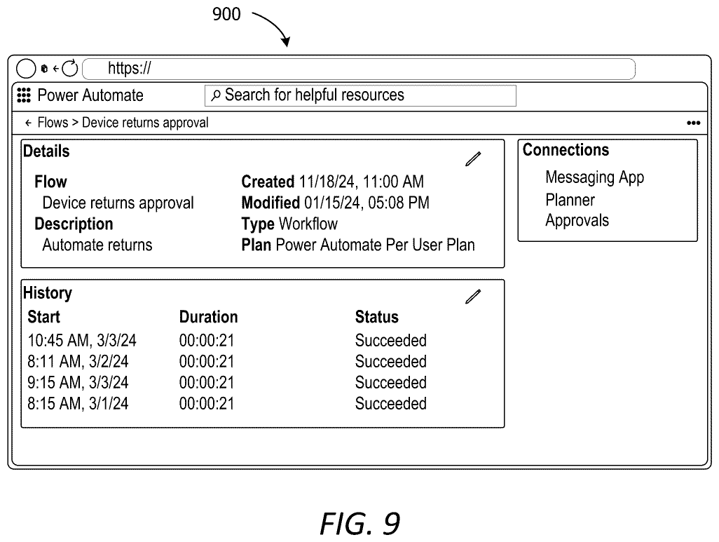

FIG. 9 is an exemplary diagram illustrating a screenshot 900 of a workflow management page including historical runtime information for a single automation plan associated with an automation workflow. In this example, the workflow management page provides historical information showing all different execution paths for a single automation plan, including dates of execution, runtime, etc.

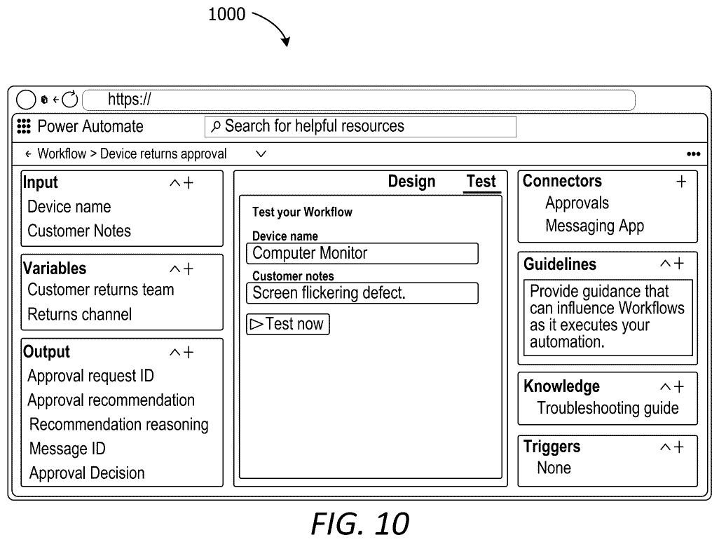

Turning now to FIG. 10, an exemplary diagram illustrating a screenshot 1000 of a prompt requesting additional information from the user during a testing phase. In this example, the automation manager prompts the user to provide a device name for a device being returned and any customer notes associated with the return. Once the additional information is entered, the user selects or clicks on the “test now” button to trigger testing of the automation plan.

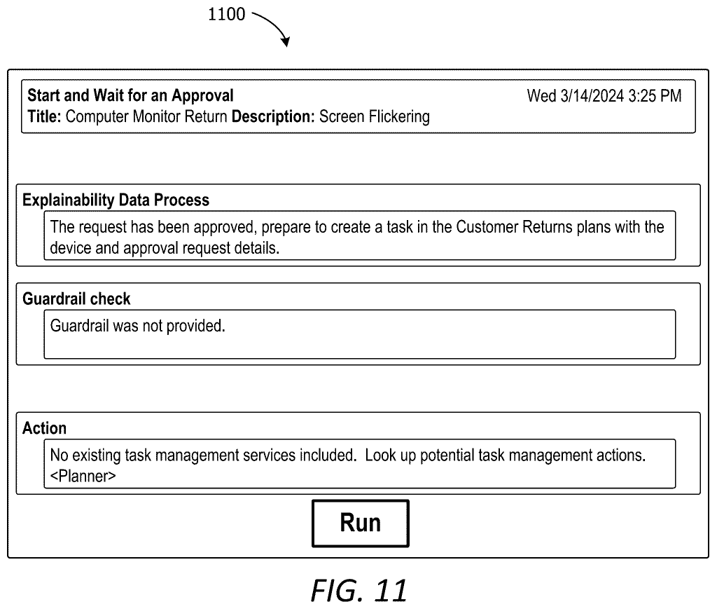

FIG. 11 is an exemplary block diagram illustrating a screenshot 1100 of an approval prompt showing explainability data, a guardrail check result and a next action to be performed. In this example, a user is prompted to provide approval to perform the next action in the plan for an optimized device return approval automation.

### Additional Examples

In some examples, the system helps a user create and improve automation plans for performing daily tasks. Once created, an automation plan is executed using a semantic kernel to execute the actions. A semantic kernel is a collection of tools, libraries and/or instructions permitting seamless integration of LLMs. In some examples, the semantic kernel includes an operating system for one or more ML models which translates natural language automation plans into machine level code The automation plan is described by the user in natural language. Rather than being executed on a pre-defined structure, an LLM engine dynamically decides the action and order or sequence of actions to be performed based on the overall automation plan.

An automation manager begins creating an automation plan based on input provided by the user describing what they want to do in natural language. The generative AI analyzes this plan and makes suggestions for improvements. Specifically, the automation manager identifies additional pieces of information that will help it execute the automation plan. For example, if the user says they want to email the “Customer Response Team”, then the AI determines that “Customer Response Team” needs to be turned into an actual email address that the execution engine would need to actually send the email, and chooses an email platform connector enabling the system to perform a “send email action” to send the actual emails.

In other examples, the system includes a closer design and validation loop where the AI can show the user the generative AI model's reasoning for choosing an action and confirm with the user before execution. Once confirmed in validation, the AI starts executing the automation plan autonomously. The guardrails are used to ensure the AI action execution always falls under the conditions specified by the user for a particular automatable resource. In this manner, the system uses natural language inputs from a user to construct an improved automation plan that executes autonomously and customizable for each automation workflow.

The system, in other examples, breaks the execution of an automation plan down into phases. The non-AI portions of the automation manager provides the initial set of goals and available actions to the LLM. The LLM breaks the overall prompt into multiple steps, each of which may call separate actions. The LLM instructs the non-AI portion of the automation manager to execute these actions. The non-AI portions of the automation manager verifies these actions align with the guard rails provided by the user and any other restrictions, and if allowed, executes these using connectors/flow actions. This multi-turn, back-and-forth conversation with the LLM continues until the goals outlined in the natural language description in the automation plans are achieved.

In some examples, the system includes an automation workflow (automatable resource) definition. The definition includes the name of the workflow, workflow description, and trigger. The trigger is a manual trigger or an event-driven trigger that triggers or starts performance of actions dictated by the automation plan for the automation workflow.

The trigger, in some examples, defines the input parameters for the automation workflow. A goal is a natural language description of what the automation workflow should do, providing all the information required to complete the goal. Any natural language ‘guardrails’ (natural language instructions to not do a particular action) also go here. A dictionary of variable string names to values are provided as additional context to the goal. For example, if the goal mentions a dynamic shared files list, a variable can define this term as the specific site and list being referenced. The automation plan directs the automation workflow to only execute actions from connectors for which it has connections (connector references). The guardrails provide constraints on the specific actions that the workflow may use. An action can include a connector action ‘plugin,’ which is effectively a closure around a connector action. In addition to referencing a specific operation in a connector, it consists of an action name, model display name, and model description. Input parameters may be ‘set’ or ‘bound’ at create time in the workflow definition by providing specific values for them. Unbound parameters are bound at runtime.

In other examples, connector operations allow the design time experience to create specialized actions, effectively closures around actions—for example instead of having a ‘Send an email’ action, a ‘Send an email to David’ action could be created. This specialization is achieved by the parameters object which allows the design time experience to bind parameter values to actions so that the AI cannot change them, enabling an additional security benefit. Each key is a property alias from the operation's manifest. Each parameter value is an object which defines a ‘source’ and some other data. This is expandable to support additional methods, such as variables. The valid parameter value formats are: {“source”: “literal”, “value”: “any JSON value, of any type”}.

In other examples, the automation manager can embed tokens using a string interpolation JSON syntax. For example, to embed a token referring to variable ‘Customer returns team’, the plan can use the text {“type”: “variable”, “name”: “Customer returns team”}. Literal brace characters ‘{‘and’}’ escaped by doubling them, i.e. ‘{{‘and’}}’. To encode send this smile:} to the customer returns team,” the automation manager creates the following text: send this smile:}} to the {“type”: “variable”, “name”: “Customer returns team”}.

In an example scenario, a user accesses a create page in the automation manager and sees an option to create a new automation plan for a given automation workflow. When the user clicks on the new automation plan landing page, the automation manager prompts (asks) the user to specify automation instructions in natural language. A new canvas page opens, with connector (approvals, inputs, outputs and group/team variables). The user adds instructions to recommend an approval by comparing input against a file with technology services group (TSG) guide. The user hits validate to walk through what the flow does with test inputs. During the testing phase, the automation manager can ask interactive questions to obtain additional information from the user. For example, the system can output a query such as, “where is the file located?”. The interactive question and answer session can include a series of natural language queries from the automation manager intended to draw out needed information to complete or otherwise improve the automation plan from the human user.

In another example scenario, a user calls the automation manager using the automation workflows connector and integrates it with any existing connectors available to the user. The user can add an action to run through the automation workflow validation when a new workflow directory entry is added and updated based on the output of the automation workflow.

In other examples, a user can also go to the workflow directory page to see all the different runs for each automation plan. The user can drill into any single automation plan execution event to see what the engine ran through for each unique run. The user can view all the different paths that the system performed during execution. Different actions may be performed in different sequence during different executions of the automation plans due to the dynamic nature of the generative AI model selecting which available actions to perform and the sequence in which the actions are performed. The system provides a seamless and user friendly automation plan creation experience with enterprise readiness providing reliable, performance and scalable runtime experiences that allow customers to run, monitor and manage automation at scale with a low code process.

The system understands a user intent and creates an automation plan for an automation workflow based on the scenario (natural language) input provided by the user. The system auto-sets up connections on the user's behalf to get a working automation ready as soon as possible. The system applies the necessary parameters in the plan based on the user inputs describing the work to be done by the automatable resource. The system responds to the user requests to make changes to the plan, such as update actions and replace actions. The user can ask the automation manager about the workflow, such as, “what does this workflow do?”.

In still other examples, the system enables the user to test an automation plan in a preview mode in which the user confirms actions before the automation proceeds to the next action in the automation plan. If the user confirms the proposed action, the proposed action is performed and the next action is submitted for preview by the user before proceeding with executing the action. The preview mode is available during design and testing phase enabling the user to have greater input and feedback to the automation, preventing errors in the plans, and ensuring more accurate and desirable automations are executed. Once the plan is placed into runtime mode, the plan is locked in and can no longer be modified dynamically. However, during the runtime phase, the system dynamically updates the automation plans with dynamic values. Dynamic values include values for variables which can change from day to day, such as file names, etc. This enables improved workflow automations with greater flexibility and scalability while simplifying the automation plan creation and testing process for users.

In still other examples, the automation manager performs a handoff procedure in which the automation plan is created and edited during a design phase. A generative AI is utilized during the design phase to identify missing connectors and other information needed to complete the automation plan. The automation plan is then handed off or made available for testing. During the testing phase, the automation manager utilizes the generative AI to identify missing connectors, variables, or other issues with the plan. The automation manager enables the user to preview steps/actions performed during the automation prior to executing each action/step in the automation. This enables the user to correct errors and edit the plan prior to runtime. The plan is not edited or modified during runtime; however, the system dynamically updates the plan with dynamic variable values during the runtime phase to automatically convert incomplete automation plans into completed automation plans for more adaptable, scalable and customizable automation.

Alternatively, or in addition to the other examples described herein, examples include any combination of the following:
obtain natural language inputs from the user via the UI device, the natural language inputs comprising the goal, parameters, and variables associated with the automation plan;
create an incomplete automation plan using the natural language inputs;
identify, by the automation manager, missing portions of the incomplete automation plan, the missing portions comprising at least one of input parameters, output parameters and action connectors;
replace the missing portions of the incomplete automation plan with variables representing each missing portion of the incomplete automation plan;
replace each variable in the incomplete automation plan as the missing portion of the information is obtained from the user during a design phase and a testing phase of the incomplete automation plan;
generate a next action explainability data comprising a description of the next action to be performed in accordance with the completed automation plan and a reason the generative AI model selected the next action to be performed in response to validation of the next action;
wherein the missing portion of the automation plan includes a missing connector action;
request access to the missing connector action from the user;
generate a variable within the automation plan representing the missing connector action;
replace the variable within the automation plan with access to the missing connector action in response to receiving the access to the missing connector action from a pool of available connector actions during the update of the incomplete automation plan;
generate a first request to the generative AI model, the first request comprising the completed automation plan, a set of actions already performed, and a request for the next action to be performed from the generative AI model, wherein the next action to be performed is selected from a pool of available actions corresponding to a plurality of available connector actions;
responsive to receiving the next action to be performed, generate a second request to the generative AI model, the second request comprising a request for validation of the next action to be performed against the set of user-configured guardrails;
responsive to receiving invalidation of the next action to be performed, generate a third request to the generative AI model for an updated next action to be performed;
responsive to receiving validation of the next action to be performed, proceed with performing the next action;
obtain a series of natural language inputs from the user via an interactive, natural language chat session;
update the incomplete automation plan using the series of natural language inputs;
obtain a series of natural language inputs describing restrictions on each action in a pool of available actions associated with the completed automation plan;
generate the set of user-configured guardrails using the series of natural language inputs;
validate each action to be performed during execution of the updated automation plan in real-time as each action is performed using the set of user-configured guardrails;
creating an incomplete automation plan using a natural language goal provided by a user via a user interface (UI) device;
detecting a missing portion of the incomplete automation plan by a generative artificial intelligence (AI) large language model (LLM);
generating a suggestion prompt including a request for the missing portion of the incomplete automation plan;
updating the incomplete automation plan in real-time using additional information provided by the user via the UI device in response to the suggestion prompt creating an updated (completed) automation plan;
validating a next action to be performed in accordance with the completed automation plan against a set of user-configured guardrails associated with the completed automation plan, the set of user-configured guardrails comprising restrictions customized for the completed automation plan;
generating explainability data comprising the next action to be performed in accordance with the completed automation plan and a reason the generative AI LLM selected the next action to be performed in response to validation of the next action;
requesting user approval to perform the next action to be performed via the UI device, wherein the next action to be performed is triggered in response to receiving the user approval via the UI device;
updating the incomplete automation plan in real-time using additional information provided by the user via the UI device in response to the suggestion prompt creating an updated (completed) automation plan automatically at a design phase of the incomplete automation plan;
updating the incomplete automation plan in real-time using additional information provided by the user via the UI device in response to the suggestion prompt creating an updated automation plan at a testing phase of the incomplete automation plan;
identifying, during a testing phase, a missing connector action within the incomplete automation plan;
pause execution of a set of actions associated with the incomplete automation plan;
generating a suggestion requesting access to the missing connector action;
presenting the suggestion to the user via the UI device during the testing phase;
responsive to receiving a user input providing access to the missing connector action, updating the incomplete automation plan enabling the generative AI LLM to access to the missing connector action and resuming execution of the completed automation plan;
obtaining a series of natural language inputs describing restrictions on each action in a pool of available actions associated with the completed automation plan;
generating the set of user-configured guardrails using the series of natural language inputs;
validating each action to be performed during execution of the completed automation plan in real-time as each action is performed using the set of user-configured guardrails;
applying the set of user-configured guardrails to validate the set of actions performed during execution of the completed automation plan during a testing phase;
generating a first request to the generative AI LLM, the first request comprising the completed automation plan, a set of actions already performed, and a request for the next action to be performed from the generative AI LLM, wherein the next action to be performed is selected from a pool of available actions corresponding to a plurality of available connector actions;
responsive to receiving the next action to be performed, generating a second request to the generative AI LLM, the second request comprising a request for validation of the next action to be performed against the set of user-configured guardrails;
responsive to receiving invalidation of the next action to be performed, generating a third request to the generative AI LLM for an updated next action to be performed;
responsive to receiving validation of the next action to be performed, triggering performance of the validated next action;
create, at a design phase, an incomplete automation plan using a natural language goal provided by a user via a user interface (UI) device;
detect, during the design phase, a missing portion of the incomplete automation plan by a generative artificial intelligence (AI) large language model (LLM);
generate, during the design phase, a suggestion prompt including a request for the missing portion of the incomplete automation plan;
update, during the design phase, the incomplete automation plan in real-time using additional information provided by the user via the UI device in response to the suggestion prompt creating a completed automation plan;
validate, during a testing phase, a next action to be performed in accordance with the completed automation plan against a set of user-configured guardrails associated with the completed automation plan, the set of user-configured guardrails comprising restrictions customized for the completed automation plan;
generate, during the testing phase, a next action explainability data comprising the next action to be performed in accordance with the completed automation plan and a reason the generative AI LLM selected the next action to be performed in response to validation of the next action;
request, during the testing phase, user approval to perform the next action to be performed via the UI device, wherein the next action to be performed is triggered in response to receiving the user approval via the UI device;
create, at the testing phase, an incomplete automation plan using a natural language goal provided by a user via a user interface (UI) device;
detect, during the testing phase, a missing portion of the incomplete automation plan by a generative artificial intelligence (AI) large language model (LLM);
generate, during the testing phase, a suggestion prompt including a request for the missing portion of the incomplete automation plan;
update, during the testing phase, the incomplete automation plan in real-time using additional information provided by the user via the UI device in response to the suggestion prompt creating an updated automation plan;
generate a first request to the generative AI LLM, the first request comprising the updated automation plan, a set of actions already performed, and a request for the next action to be performed from the generative AI LLM, wherein the next action to be performed is selected from a pool of available actions corresponding to a plurality of available connector actions;
responsive to receiving the next action to be performed, generate a second request to the generative AI LLM, the second request comprising a request for validation of the next action to be performed against the set of user-configured guardrails;
responsive to receiving invalidation of the next action to be performed, generate a third request to the generative AI LLM for an updated next action to be performed;
responsive to receiving validation of the next action to be performed, perform the next action;
generate a first request to a first generative AI LLM, the first request comprising the updated automation plan, a set of actions already performed, and a request for the next action to be performed from the generative AI LLM, wherein the next action to be performed is selected from a pool of available actions corresponding to a plurality of available connector actions;
responsive to receiving the next action to be performed, generate a second request to a second generative AI LLM, the second request comprising a request for validation of the next action to be performed against the set of user-configured guardrails;
responsive to receiving invalidation of the next action to be performed, generate a third request to the first generative AI LLM for an updated next action to be performed;
responsive to receiving validation of the next action to be performed, trigger performing the validated next action;
obtain a series of natural language inputs from the user via an interactive, natural language chat session during the design phase;
update the incomplete automation plan using the series of natural language inputs during the design phase;
obtain a series of natural language inputs from the user via an interactive, natural language chat session during the testing phase;
update the incomplete automation plan using the series of natural language inputs during the testing phase;
automatically execute the completed automation plan;
wherein executing the completed automation plan comprises at least one of sending instructions to a digital robot, sending instructions to a physical robot, sending instructions to an email server, or sending instructions to a file system; and
binding parameter values to actions, wherein the generative AI LLM cannot change the parameter values at runtime.

At least a portion of the functionality of the various elements in FIG. 1, FIG. 2, FIG. 3, and FIG. 12 can be performed by other elements in FIG. 1, FIG. 2, FIG. 3, and FIG. 12, or an entity (e.g., processor 106, web service, server, application program, computing device, etc.) not shown in FIG. 1, FIG. 2, FIG. 3, and FIG. 12.

In some examples, the operations illustrated in FIG. 4, FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of dynamic automation plan creation and validation, the method comprising creating an incomplete automation plan using a natural language goal provided by a user via a user interface (UI) device; detecting a missing portion of the incomplete automation plan by a generative artificial intelligence (AI) large language model (LLM); generating a suggestion prompt including a request for the missing portion of the incomplete automation plan; updating the incomplete automation plan in real-time using additional information provided by the user via the UI device in response to the suggestion prompt creating an updated automation plan; validating a next action to be performed in accordance with the updated automation plan against a set of user-configured guardrails associated with the updated automation plan, the set of user-configured guardrails comprising restrictions customized for the updated automation plan; generating a next action explainability data comprising the next action to be performed in accordance with the updated automation plan and a reason the generative AI LLM selected the next action to be performed in response to validation of the next action; and requesting user approval to perform the next action to be performed via the UI device, wherein the next action to be performed is triggered in response to receiving the user approval via the UI device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

FIG. 12 is a block diagram of an example computing device 1200 for implementing aspects disclosed herein and is designated as computing device 1200. The computing device 1200 is a computing device, such as the computing device 102 in FIG. 1. The computing device 1200 is an example of a suitable computing environment and is not intended to suggest any limitation as to the scope of use or functionality of the examples disclosed herein. Neither should the computing device 1200 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device.

Program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1200 includes a bus 1210 that directly or indirectly couples the following devices: computer-storage memory 1212, one or more processors 1214, one or more presentation component(s) 1216, I/O ports 1218, I/O components 1220, a power supply 1222, and a network component 1224. While computing device 1200 is depicted as a single device, multiple computing devices 1200 may work together and share the depicted device resources. For example, memory 1212 may be distributed across multiple devices, and processor(s) 1214 may be housed with different devices.

Bus 1210 represents what may be one or more buses (such as an address bus, data bus, or a combination thereof). Although the various blocks of FIG. 12 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 12 and the references herein to a “computing device.”

Memory 1212 may take the form of the computer-storage media references below and operatively provide storage of computer-readable instructions, data structures, program modules and other data for computing device 1200. In some examples, memory 1212 stores one or more of an operating system, a universal application platform, or other program modules and program data. Memory 1212 is thus able to store and access data 1212a and instructions 1212b that are executable by processor 1214 and configured to carry out the various operations disclosed herein.

In some examples, memory 1212 includes computer-storage media in the form of volatile and/or nonvolatile memory, removable or non-removable memory, data disks in virtual environments, or a combination thereof. Memory 1212 may include any quantity of memory associated with or accessible by computing device 1200. Memory 1212 may be internal to computing device 1200 (as shown in FIG. 12), external to computing device 1200 (not shown), or both (not shown).

Examples of memory 1212 in include, without limitation, RAM; read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1200. Additionally, or alternatively, memory 1212 may be distributed across multiple computing devices 1200, for example, in a virtualized environment in which instruction processing is carried out on multiple computing devices 1200. For the purposes of this disclosure, “computer storage media,” “computer storage device,” “computer-storage memory,” “memory,” and “memory devices” are synonymous terms for computer-storage memory 1212, and none of these terms include carrier waves or propagating signaling. In some examples, the memory 1212 is a memory such as, but not limited to, the memory 108 in FIG. 1.

Processor(s) 1214 may include any quantity of processing units that read data from various entities, such as memory 1212 or I/O components 1220 and may include CPUs and/or GPUs. Specifically, processor(s) 1214 are programmed to execute computer-executable instructions for implementing aspects of the disclosure. The instructions may be performed by the processor, by multiple processors within computing device 1200, or by a processor external to client computing device 1200. In some examples, processor(s) 1214 are programmed to execute instructions such as those illustrated in the in the accompanying drawings.

Moreover, in some examples, processor(s) 1214 represent an implementation of analog techniques to perform the operations described herein. For example, the operations may be performed by an analog client computing device 1200 and/or a digital client computing device 1200. In some examples, the processor(s) 1214 include one or more processors, such as but not limited to, the processor 106 in FIG. 1.

Presentation component(s) 1216 present data indications to a user or other device. Exemplary presentation components include a display device, speaker, printing component, vibrating component, etc. One skilled in the art will understand and appreciate that computer data may be presented in a number of ways, such as visually in a GUI, audibly through speakers, wirelessly between computing devices 1200, across a wired connection, or in other ways. I/O ports 1218 allow computing device 1200 to be logically coupled to other devices including I/O components 1220, some of which may be built in. Example I/O components 1220 include, for example but without limitation, a microphone, joystick, game pad, satellite dish, scanner, printer, wireless device, etc.

Computing device 1200 may operate in a networked environment via network component 1224 using logical connections to one or more remote computers. In some examples, network component 1224 includes a network interface card and/or computer-executable instructions (e.g., a driver) for operating the network interface card. Communication between computing device 1200 and other devices may occur using any protocol or mechanism over any wired or wireless connection.

In some examples, network component 1224 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1224 communicates over wireless communication link 1226 and/or a wired communication link 1226a to a cloud resource 1228 across network 1230. Various different examples of communication links 1226 and 1226a include a wireless connection, a wired connection, and/or a dedicated link, and in some examples, at least a portion is routed through the internet.

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for improving automation plans using generative AI. For example, the elements illustrated in FIG. 1, FIG. 2, FIG. 3, and FIG. 12 such as when encoded to perform the operations illustrated in FIG. 4, FIG. 5, FIG. 6, and FIG. 7, constitute exemplary means for creating, at a design phase, an incomplete automation plan using a natural language goal provided by a user via a user interface (UI) device; exemplary means for detecting, during the design phase, a missing portion of the incomplete automation plan by a generative artificial intelligence (AI) large language model (LLM); exemplary means for generating, during the design phase, a suggestion prompt including a request for the missing portion of the incomplete automation plan; exemplary means for updating, during the design phase, the incomplete automation plan in real-time using additional information provided by the user via the UI device in response to the suggestion prompt creating an updated automation plan; exemplary means for validating, during a testing phase, a next action to be performed in accordance with the updated automation plan against a set of user-configured guardrails associated with the updated automation plan, the set of user-configured guardrails comprising restrictions customized for the updated automation plan; exemplary means for generating, during the testing phase, explainability data comprising the next action to be performed in accordance with the updated automation plan and a reason the generative AI LLM selected the next action to be performed in response to validation of the next action; and exemplary means for requesting, during the testing phase, user approval to perform the next action to be performed via the UI device, wherein the next action to be performed is triggered in response to receiving the user approval via the UI device.

Other non-limiting examples provide one or more computer storage devices having a first computer-executable instructions stored thereon for creating and validating automation plans. When executed by a computer, the computer performs operations including detect a missing portion of an automation plan by a generative artificial intelligence (AI) model; replace the missing portion with a variable; generate a suggestion prompt including a request for the missing portion of the automation plan; update the automation plan in real-time using additional information provided by the user via the UI device in response to receiving the additional information via a natural language input from the user; replace the variable with missing information needed to complete the automation plan; validate a next action to be performed in accordance with the completed automation plan against a set of user-configured guardrails associated with the completed automation plan, the set of user-configured guardrails comprising a restriction on an action associated with the completed automation plan; and request user approval to perform the next action to be performed via the UI device, wherein the next action to be performed is triggered in response to receiving the user approval via the UI device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ ”only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic automation plan creation and validation, the system comprising:
a processor; and
a computer-readable medium storing instructions that are operative upon execution by the processor to:
detect a missing portion of an incomplete automation plan by a generative artificial intelligence (AI) model, wherein the incomplete automation plan describes a set of actions for accomplishing a goal;
replace the missing portion of the incomplete automation plan with a variable representing the missing portion of the incomplete automation plan;
generate a suggestion including a request for additional information corresponding to the missing portion of the incomplete automation plan;
obtain the additional information from a natural language input received in response to the generated suggestion via a user interface (UI) device;
replace the variable in the incomplete automation plan with the additional information during a design phase or a testing phase of the incomplete automation plan, wherein replacing the variable with the additional information updates the incomplete automation plan to automatically create a completed automation plan; and
storing the completed automation plan in a data storage device for execution during a runtime phase, the completed automation plan having an absence of missing portions.

2. The system of claim 1, wherein the instructions are further operative to automatically execute the completed automation plan.

3. The system of claim 1, wherein executing the completed automation plan comprises at least one of sending instructions to a digital robot, sending instructions to a physical robot, sending instructions to an email server, or sending instructions to a file system.

4. The system of claim 1, wherein the instructions are further operative to:
identify, by an automation manager, a plurality of missing portions of the incomplete automation plan, the plurality of missing portions comprising at least one of input parameters, output parameters and action connectors; and
replace the plurality of missing portions of the incomplete automation plan with a plurality of variables representing each missing portion of the incomplete automation plan; and
replace each variable in the plurality of variables of the incomplete automation plan as the additional information corresponding with each missing portion of the incomplete automation plan is obtained during the design phase or the testing phase of the incomplete automation plan.

5. The system of claim 1, wherein the instructions are further operative to:
generate a first request to the generative AI model, the first request comprising the completed automation plan, a set of actions already performed, and a request for the next action to be performed from the generative AI model, wherein the next action to be performed is selected from a pool of available actions corresponding to a plurality of available connector actions;
responsive to receiving the next action to be performed, generate a second request to the generative AI model, the second request comprising a request for validation of the next action to be performed against a set of guardrails;
responsive to receiving invalidation of the next action to be performed, generate a third request to the generative AI model for an updated next action to be performed; and
responsive to receiving the validation of the next action to be performed, proceed with performing the next action.

6. The system of claim 1, wherein the instructions are further operative to:
validate a next action to be performed in accordance with the completed automation plan against a set of guardrails associated with the completed automation plan, the set of guardrails comprising a restriction on an action associated with the completed automation plan; and
request user approval to perform the next action to be performed via the UI device, wherein the next action to be performed is triggered in response to receiving user approval via the UI device.

7. The system of claim 1, wherein the instructions are further operative to:
obtain a series of natural language inputs describing restrictions on each action in a pool of available actions associated with the completed automation plan;
generate a set of guardrails using the series of natural language inputs; and
validate each action to be performed during execution of the completed automation plan in real-time as each action is performed using the set of guardrails.

8. A method for dynamic automation plan creation and validation, the method comprising:
creating an incomplete automation plan using natural language inputs provided by a user via a user interface (UI) device;
detecting a missing portion of the incomplete automation plan by a generative artificial intelligence (AI) large language model (LLM);
replacing the missing portion of the incomplete automation plan with a variable representing the missing portion of the incomplete automation plan;
generating a suggestion including a request for the missing portion of the incomplete automation plan represented by the variable;
updating the incomplete automation plan in real-time using additional information obtained in response to the suggestion to automatically create a completed automation plan, wherein updating the incomplete automation plan comprises replacing the variable with the missing portion of the incomplete automation plan using the additional information; and
storing the completed automation plan in a data storage device for execution during a runtime phase.

9. The method of claim 8, further comprising:
validating a next action to be performed in accordance with the completed automation plan against a set of guardrails associated with the completed automation plan, the set of guardrails comprising restrictions customized for the completed automation plan;
generating explainability data comprising the next action to be performed in accordance with the completed automation plan and a reason the generative AI LLM selected the next action to be performed in response to validation of the next action; and
requesting user approval to perform the next action to be performed via the UI device, wherein the next action to be performed is triggered in response to receiving the user approval via the UI device.

10. The method of claim 8, further comprising:
updating the incomplete automation plan in real-time using additional information provided by the user via the UI device in response to the suggestion creating the completed automation plan at a testing phase of the incomplete automation plan.

11. The method of claim 8, further comprising:
identifying, a missing connector action within the incomplete automation plan;
generating the suggestion, including a request for access to the missing connector action;
presenting the suggestion to the user via the UI device;
responsive to receiving a user input providing access to the missing connector action, updating the incomplete automation plan enabling the generative AI LLM to access to the missing connector action; and
storing the automation plan.

12. The method of claim 11 wherein the identifying is performed during a testing phase, wherein subsequent to the identifying and prior to the generating of the suggestion, execution of a set of actions associated with the incomplete automation plan is paused, and wherein the presenting of the suggestion is performed during the testing phase and wherein the method comprises resuming execution of the automation plan subsequent to the updating.

13. The method of claim 8, further comprising:
applying a set of guardrails to validate the set of actions performed during execution of the completed automation plan during a testing phase.

14. The method of claim 8, further comprising:
generating a first request to the generative AI LLM, the first request comprising the completed automation plan, a set of actions already performed, and a request for the next action to be performed from the generative AI LLM, wherein the next action to be performed is selected from a pool of available actions corresponding to a plurality of available connector actions;
responsive to receiving the next action to be performed, generating a second request to the generative AI LLM, the second request comprising a request for validation of the next action to be performed against a set of guardrails;
responsive to receiving invalidation of the next action to be performed, generating a third request to the generative AI LLM for an updated next action to be performed; and
responsive to receiving the validation of the next action to be performed, triggering performance of the next action.

15. One or more computer storage devices having computer-executable instructions stored thereon, which, upon execution by a computer, cause the computer to perform operations comprising:
creating an incomplete automation plan using a natural language goal provided by a user via a user interface (UI) device;
detecting a missing portion of the incomplete automation plan by a generative artificial intelligence (AI) large language model (LLM);
replacing the missing portion of the incomplete automation plan with a variable representing the missing portion of the incomplete automation plan;
generating a suggestion including a request for the missing portion of the incomplete automation plan;
updating the incomplete automation plan in real-time using additional information obtained from a natural language response in response to the suggestion automatically creating a completed automation plan, the updating comprising replacing the variable with the missing portion of the incomplete automation plan obtained from the additional information to generate a completed automation plan;
validating a next action to be performed in accordance with the completed automation plan against a set of guardrails associated with the completed automation plan, the set of guardrails comprising restrictions customized for the completed automation plan;
generating explainability data comprising the next action to be performed in accordance with the completed automation plan and a reason the generative AI LLM selected the next action to be performed in response to validation of the next action; and
requesting user approval to perform the next action to be performed via the UI device, wherein the next action to be performed is triggered in response to receiving the user approval via the UI device.

16. The one or more computer storage devices of claim 15, wherein the operations further comprise:
creating, at a testing phase, the incomplete automation plan using the natural language goal provided by the user via a UI device;
detecting, during the testing phase, the missing portion of the incomplete automation plan by the generative AI LLM;
generating, during the testing phase, the suggestion, including a request for the missing portion of the incomplete automation plan;
updating, during the testing phase, the incomplete automation plan in real-time using additional information provided by the user via the UI device in response to the suggestion creating the completed automation plan; and
executing the completed automation plan.

17. The one or more computer storage devices of claim 15, wherein the operations further comprise:
generating a first request to the generative AI LLM, the first request comprising the completed automation plan, a set of actions already performed, and a request for the next action to be performed from the generative AI LLM, wherein the next action to be performed is selected from a pool of available actions corresponding to a plurality of available connector actions;
responsive to receiving the next action to be performed, generating a second request to the generative AI LLM, the second request comprising a request for validation of the next action to be performed against the set of guardrails;
responsive to receiving invalidation of the next action to be performed, generating a third request to the generative AI LLM for an updated next action to be performed; and
responsive to receiving the validation of the next action to be performed, performing the next action.

18. The one or more computer storage devices of claim 15, wherein the operations further comprise:
generating a first request to a first generative AI LLM, the first request comprising the completed automation plan, a set of actions already performed, and a request for the next action to be performed from the generative AI LLM, wherein the next action to be performed is selected from a pool of available actions corresponding to a plurality of available connector actions;
responsive to receiving the next action to be performed, generating a second request to a second generative AI LLM, the second request comprising a request for validation of the next action to be performed against the set of guardrails;
responsive to receiving invalidation of the next action to be performed, generating a third request to the first generative AI LLM for an updated next action to be performed; and
responsive to receiving the validation of the next action to be performed, triggering performing the next action.

19. The one or more computer storage devices of claim 15, wherein the operations further comprise:
obtaining a series of natural language inputs from the user via an interactive, natural language chat session during a design phase or a testing phase; and
updating the incomplete automation plan using the series of natural language inputs during the design phase or the testing phase.

20. The one or more computer storage devices of claim 15, wherein the operations further comprise:
binding parameter values to actions, wherein the generative AI LLM cannot change the parameter values at runtime.
